(19) United States
(12) Patent Application Publication
(10) Pub. No.: US 2018/0202219 A1
(43) Pub. Date: Jul. 19, 2018

(54) MOUNTING ASSISTANT PLATE

(71) Applicant: Chin-Fu CHEN, TAICHUNG CITY (TW)

(72) Inventor: Po-Yu CHEN, TAICHUNG CITY (TW)

(21) Appl. No.: 15/408,978

(22) Filed: Jan. 18, 2017

(51) Int. Cl. E06B 9/266; E04F 21/00; G01B 5/02

(52) U.S. Cl. CPC E06B 9/266; G01B 5/02; E04F 21/003

(57) ABSTRACT

A mounting assistant plate includes an abutment end, an opposing index end, and an index hole located at the index end. In application, abut the abutment end against the supporting object (wall or window frame), and then mark a mark on the supporting object corresponding to each index hole for the indication of a respective mounting hole to be drilled, facilitating subsequent mounting of a window blind rail holder.

### BACKGROUND OF THE INVENTION

### 1. Field of the Invention

The present invention relates to window blind technology and more particularly, to a mounting assistant plate for assisting the mounting of a window blind rail holder rapidly and conveniently.

### 2. Description of the Related Art

When mounting a window blind rail holder, it is the normal way to mark a mark on the wall or window frame at each selected location using a scale, and then to drill a mounting hole on each mark, and then to affix the window blind rail holder to the wall or window frame by driving fastening members (such as screws) through the window blind rail holder into the marked locations. However, it is prone to error and less efficient when marking a mark on each selected location with the assistance of a scale. Therefore, this conventional method is not satisfactory in function.

### SUMMARY OF THE INVENTION

The present invention has been accomplished under the circumstances in view. It is the main object of the present invention to provide a mounting assistant plate, which assists the user to mark a mounting position on the wall of window frame accurately and rapidly, facilitating subsequent mounting of a window blind rail holder.

To achieve this and other objects of the present invention, a mounting assistant plate comprises an abutment end, an index end opposite to the abutment end, and at least one index hole located at the index end. In application, abut the abutment end against the supporting object (wall or window frame), and then mark a mark on the supporting object corresponding to each index hole for the indication of a respective mounting hole to be drilled. After the desired mounting holes are made, a window blind rail holder can then be affixed to the mounting holes at the supporting object with fastening members.

Preferably, the mounting assistant plate further comprises a description zone marked on a surface thereof. The description zone has contained therein a descriptive text, descriptive graphics, or their combination. The user immediately knows how to use the mounting assistant plate when viewed the description zone.

Preferably, the index hole is an elongated hole, providing room for fine adjustment during installation of a fastening member to affix the window blind rail holder to the supporting object.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a mounting assistant plate in accordance with the present invention.

FIG. 2 is a schematic drawing illustrating an application example of the mounting assistant plate in accordance with the present invention.

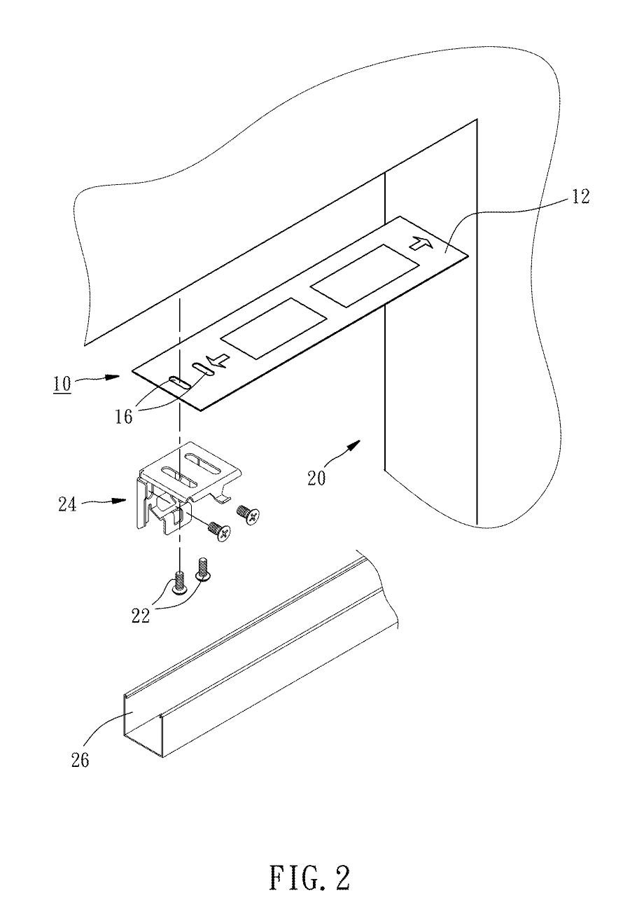

### DETAILED DESCRIPTION OF THE INVENTION

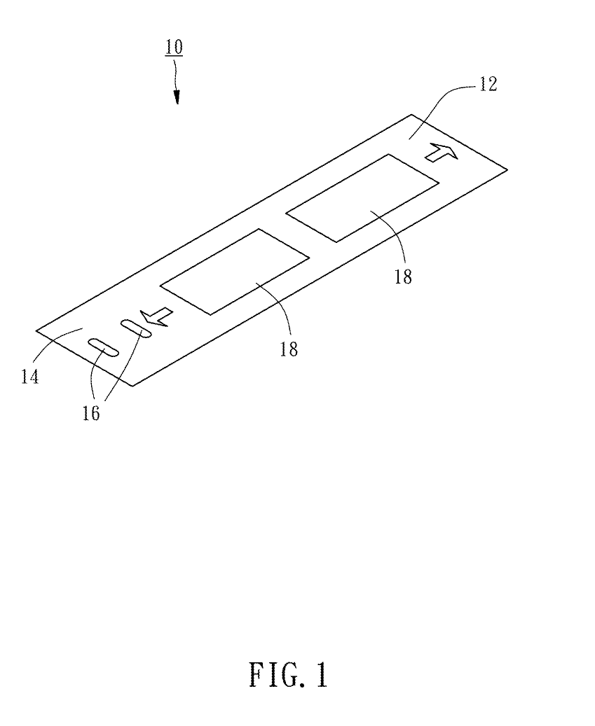

Referring to FIG. 1, a mounting assistant plate 10 in accordance with the present invention is shown. The mounting assistant plate 10 is made from a rectangular paperboard, comprising, in structure, an abutment end 12, an opposing index end 14, and two elongated index holes 16 located at the index end 14 and transversely disposed in a parallel manner. The mounting assistant plate 10 further comprises one or multiple description zones 18 marked on the surface thereof. Each description zone 18 has contained therein for example, but not limited to, a descriptive text, descriptive graphics, or their combination. The user immediately knows how to use the mounting assistant plate 10 when viewed the description zones 18.

In application, abut the abutment end 12 of the mounting assistant plate 10 against one side of the supporting object 20 (such as wall or window frame) in which the window blind to be installed, and then closely attach the mounting assistant plate 10 to an inner top surface of the supporting object 20, and then mark marks on the inner top surface of the supporting object 20 corresponding to the elongated index holes 16. After marking, drill mounting holes on the marks, and then insert fastening members 22 (such as screws) through the window blind rail holder 24 and drive these fastening members 22 into the supporting object 20 to affix the window blind rail holder 24 to the supporting object 20. During the installation procedure, the mounting position of the window blind rail holder 24 can be fine-adjusted using the index holes 16. After fixation of the window blind rail holder 24, a top rail 26 can then be fastened to the window blind rail holder 24.

Thus, subject to the assistance of the mounting assistant plate 10, the user can rapidly and accurately mark marks on the surface of a wall, window frame, or any other supporting object to indicate the location for the installation of a window blind rail holder. Further, the length of the mounting assistant plate 10 can be modified subject to the size of the window blind to be installed, keeping the index hole 16 in the accurate position, minimizing installation error and enhancing installation convenience.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A mounting assistant plate for assisting the mounting of a window blind rail holder in a supporting object, the mounting assistant plate comprising an abutment end for abutting against said supporting object, an index end opposite to said abutment end, and at least one index hole located at said index end.

2. The mounting assistant plate as claimed in claim 1, wherein said mounting assistant plate further comprises a description zone marked on a surface thereof.

3. The mounting assistant plate as claimed in claim 2, wherein said description zone has contained therein a descriptive text, descriptive graphics, or their combination.

4. The mounting assistant plate as claimed in claim 1, wherein said index hole is an elongated hole.

5. The mounting assistant plate as claimed in claim 1, wherein said mounting assistant plate is made from paperboard.

6. The mounting assistant plate as claimed in claim 1, wherein said mounting assistant plate exhibits a rectangular shape.
